(19) United States
(12) Patent Application Publication
(10) Pub. No.: US 2026/0331339 A1
(43) Pub. Date: Oct. 22, 2026

(54) SOFT MAGNETIC METALPOWDER, MAGNETIC CORE, MAGNETIC COMPONENT, AND ELECTRONIC DEVICE

(71) Applicant: TDK CORPORATION, Tokyo (JP)

(72) Inventors: Masakazu HOSONO, Tokyo (JP); Kazuhiro YOSHIDOME, Tokyo (JP); Hiroyuki MATSUMOTO, Tokyo (JP)

(73) Assignee: TDK CORPORATION, Tokyo (JP)

(21) Appl. No.: 19/651,951

(22) Filed: Apr. 20, 2026

(30) Foreign Application Priority Data
Apr. 21, 2025 (JP) 2025-069823

(51) Int. Cl. H01F 1/147; H01F 1/20

(52) U.S. Cl. CPC H01F 1/14791; H01F 1/20

(57) ABSTRACT

A soft magnetic metal powder, including: a soft magnetic metal particle comprising a core part and a covering part, wherein the covering part comprises a C-concentrated part having a higher concentration of C than in the core part.

### TECHNICAL FIELD

The present disclosure relates to a soft magnetic metal powder, a magnetic core, a magnetic component, and an electronic device.

### BACKGROUND

Patent Document 1 discloses a core using a composite magnetic material made by mixing an insulation binder with a magnetic powder mixture obtained by mixing an iron-based crystalline alloy magnetic powder and an iron-based amorphous alloy powder.

In Patent Document 2, a heat curable resin is coating each particle included in a magnetic powder mixture obtained by mixing a hard amorphous alloy magnetic powder and a Fe—Ni-based alloy magnetic powder to give a composite magnetic material. Such composite magnetic material is used in an inductor disclosed in Patent Document 2.

### PRIOR ART DOCUMENT

### Patent Document

[Patent Document 1] JP Patent Application No. 2004-197218A
[Patent Document 2] JP Patent Application No. 2004-363466A

### SUMMARY

A soft magnetic metal powder according to the present disclosure, includes: a soft magnetic metal particle including a core part and a covering part, wherein the covering part includes a C-concentrated part having a higher concentration of C than in the core part.

### BRIEF DESCRIPTION OF DRAWINGS

FIG. 1 is a schematic cross-sectional view of a soft magnetic metal particle.

FIG. 2 is an example chart generated using an X-ray crystallography.

FIG. 3 is an example pattern obtained by profile fitting the chart of FIG. 2.

FIG. 4 is a schematic view of a Weibull plot.

FIG. 5 is a schematic cross-sectional view of a powder coating device.

### DETAILED DESCRIPTION

It is an object of the present disclosure to provide a soft magnetic metal powder with a high voltage resistance and a small variation in withstand voltage.

In the soft magnetic metal powder according to the present disclosure, the coating part may have an oxide part contacting a surface of the core part.

In the soft magnetic metal powder according to the present disclosure, a local maximum of the concentration of C in the C-concentrated part (C(LM)) may be ten times or greater than the concentration of C in the soft magnetic metal powder (C(P)).

In the soft magnetic metal powder according to the present disclosure, a thickness of the C-concentrated part may be 0.5 nm or thicker and 50.0 nm or thinner.

The soft magnetic metal powder according to the present disclosure, the covering part may include an outer coating part contacting a surface of the C-concentrated part.

A magnetic core according to the present disclosure includes the above-mentioned soft magnetic metal powder.

A magnetic component according to the present disclosure includes the above mentioned soft magnetic metal powder.

An electronic device according to the present disclosure includes the above-mentioned soft magnetic metal powder.

Hereinafter, a soft magnetic metal powder, etc., according to the embodiments of the present disclosure will be described. In the figures used in the below description, a characteristic part may be enlarged for easier understanding of the characteristics of the present disclosure; hence, a proportion of the dimension of each configuration element may not precisely match the actual dimension. Materials, dimensions, etc., mentioned in below description are merely an example; and, the present disclosure is not limited to these. The materials, dimensions, etc., may change accordingly within the scope of the present disclosure as long as such change does not exceed the gist of the present disclosure.

A magnetic core according to the present embodiment includes the soft magnetic metal powder as a magnetic material.

Further, the magnetic core may include a resin. The resin may be any type, and the amount of the resin is not particularly limited. Examples of types of the resin include heat curable resins, such as a phenol resin and an epoxy resin. The amount of the resin may be 1 mass % or more and 5 mass % or less with respect to the amount of the magnetic powder.

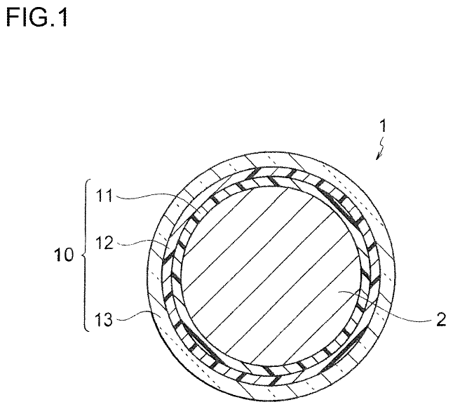

FIG. 1 shows a schematic cross-sectional view of a soft magnetic metal particle 1 included in the soft magnetic metal powder. As shown in FIG. 1, the soft magnetic metal particle 1 has a core part 2 and a covering part 10.

### (Core Part 2)

A composition of the core part 2 is not particularly limited as long as the core part 2 becomes a soft magnetic metal. For example, the core part 2 may be an iron-based soft magnetic metal in which a total amount of Fe, Co, and Ni is 75 at % or greater, and a ratio of Fe is 50 at % or greater with respect to the total amount of Fe, Co, and Ni. Further, in the core part 2, when a ratio of Co is 1 at % or greater and 50 at % or less with respect to the total amount of Fe, Co, and Ni, a C-concentrated part is readily formed in the covering part 10. Thus, the soft magnetic metal powder having such characteristic can be easily used for manufacturing the later-described magnetic core having a large m-value and a small variation in withstand voltage.

When the core part 2 is the iron-based soft magnetic metal, a coercivity Hc of the magnetic core is lowered, and a relative permeability tends to further improve.

The core part 2 is normally significantly larger than the covering part 10. The composition of the soft magnetic metal powder, the composition of the soft magnetic metal particle 1, and the composition of the core part 2 are deemed substantially the same.

The soft magnetic metal powder may have any composition. Examples of the composition include a Fe—Co—B—P—Si—Cr-based composition, a Fe—Si—B-based composition, a Fe—Si—B—C-based composition, a Fe—Si—B—C—Cr-based composition, a Fe—Co—P—C-based composition, a Fe—Co—B-based composition, and a Fe—Co—B—Si-based composition, which tend to form an amorphous structure. Also, other examples of the composition include a Fe—Si—B—Nb—Cu-based composition, a Fe—Si—B—Nb—P-based composition, a Fe—Co—B—P—Si-based composition, and a Fe—Co—B—P—Si—Cr-based composition, which tend to form a nanocrystal structure. Further other examples of the composition include a Fe—Si-based composition, a in Fe-based composition, a Fe—Ni-based composition, a Fe—Si—Cr-based composition, a Fe—Si—Al-based composition, a Fe—Si—Al—Ni-based composition, a Fe—Ni—Si—Co-based composition, a Fe—Co-based composition, a Fe—Co—V-based composition, a Fe—Co—Si-based composition, and a Fe—Co—Si—Al-based composition, which tend to form a crystal structure.

The composition of the soft magnetic metal particle 1 may be represented by a formula Fe_{(1-(α+β)}X1_{α}X2_{β})_{(1-(a+b+c+d+e+f)}MₐB_{b}P_{c}Si_{d}CₑS_{f} which is in terms of an atomic ratio. X1 is one or more selected from the group consisting of Co and Ni; X2 is one or more selected from the group consisting of Al, Mn, Ag, Zn, Sn, As, Sb, Cu, Cr, Bi, N, O, and rare earth elements; and Mis one or more selected from the group consisting of Nb, Hf, Zr, Ta, Mo, W, Ti, and V. Further, in the above formula, followings are satisfied:
0≤a≤0.150,
0≤b≤0.200,
0≤c≤0.200,
0≤d≤0.200,
0≤e≤0.200,
0≤f≤0.0200,
α≥0,
β≥0, and
0≤α+β≤0.50.

When the composition satisfies the above-mentioned ranges, the coercivity of the magnetic core tends to be lower, and a relative permeability of the magnetic core tends to increase.

Further, the composition of the soft magnetic metal particle may satisfy 0.100≤a+b+c+d+e≤0.300. When the composition satisfies the above-mentioned ranges and further satisfies the relation of 0.100≤a+b+c+d+e≤0.300, the amorphous structure and the nanocrystal structure tend to be formed, and the coercivity tends to lower, and, the relative permeability of the magnetic core tends to increase.

The soft magnetic metal particle 1 (core part 2) may include inevitable impurity elements other than the elements mentioned in above (i.e., Fe, X1, X2, M, B, P, Si, C, and S). For example, the soft magnetic metal particle (core part 2) may include 0.1 mass % or less of the inevitable impurity elements.

The core part 2 may have any fine structure. It may have an amorphous structure, a nanocrystal structure, or a crystal structure.

An amorphous structure refers to a structure having an amorphous ratio X of 85% or more. A structure, in which crystals are contained to the extent that the amorphous ratio reaches 85% or greater is included, in the amorphous structure. The amorphous structure includes an approximately amorphous structure or a hetero-amorphous structure. A hetero-amorphous structure refers to a structure in which crystals are present in an amorphous solid. When the core part 2 has a hetero-amorphous structure, the average crystal size of crystals in the amorphous solid may be 0.1 nm or greater and 10 nm or less. A nanocrystal structure refers to a structure having an amorphous ratio X of less than 85% and an average crystal size of 100 nm or less. The average crystal size of the crystals in the nanocrystal structure may be 3 nm or greater and 50 nm or less. A crystal structure refers to a structure having an amorphous ratio X of less than 85% and an average crystal size of greater than 100 nm.

The amorphous ratio X can be measured by an X-ray crystallography using XRD or may be measured using an electron backscattered diffraction (EBSD) or an electron diffraction. Hereinafter, a method of measuring the amorphous ratio by an X-ray crystallography using XRD will be described.

The amorphous ratio X of the soft magnetic metal powder is represented by Formula 1 shown below.

X=100−(Ic/(Ic+Ia)×100) Formula 1
Ic: Crystal scattering integrated intensity
Ia: Amorphous scattering integrated intensity

The amorphous ratio X is calculated as follows. An X-ray crystallography using XRD is conducted to the soft magnetic metal powder. In the analysis, phases are identified, and peaks (Ic: crystal scattering integrated intensity, Ia: amorphous scattering integrated intensity) of crystallized Fe or a crystallized compound are read. From the intensities of these peaks, the crystallization ratio is determined, and the amorphous ratio X is calculated using the above Formula 1. Below describes the calculation method in further detail.

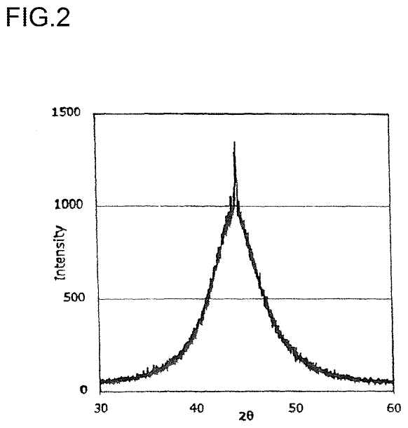

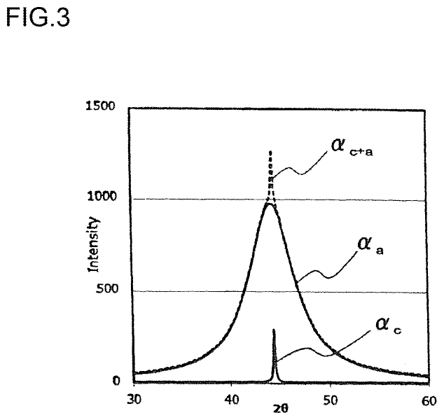

The X-ray crystallography using XRD is conducted to the soft magnetic metal powder to generate a chart like the one shown as FIG. 2. Then, profile fitting is conducted to this chart using a Lorentzian function shown in below Formula 2 to generate a crystal component pattern dc showing the crystal scattering integrated intensity, an amorphous component pattern da showing the amorphous scattering integrated intensity, and a pattern Octa showing a combination of these patterns, as shown in FIG. 3. From the patterns of the crystal scattering integrated intensity and the amorphous scattering integrated intensity, the amorphous ratio X is calculated using the above Formula 1. Note that, a measurement range of a diffraction angle 2θ in which amorphous-derived halos can be confirmed is within a range of 2θ=30° to 60°. Within this range, the difference between the actual integrated intensities measured using XRD and the integrated intensities calculated using the Lorentzian function is within 1%.

$$f ( x ) = \frac{h}{1 + \frac{{( x - u )}^{2}}{{w}^{2}}} + b \qquad Formula 2$$

$$h : Peak height$$

$$u : Peak location$$

$$w : Full width at half maximum$$

$$b : Background height$$

An average particle size of the soft magnetic metal powder 1 is not particularly limited. For example, it may be 1 μm or larger and 50 μm or smaller. In the case of using the soft magnetic metal powder 1 with small average particle size, the withstand voltage tends to become large and the variation in the withstand voltage tends to be smaller. In the case that filing factors of the magnetic cores are the same, the smaller the average particle size of the soft magnetic metal powder 1, the lower the relative permeability of the magnetic core tends to be.

Methods of measuring a thickness of each part of the soft magnetic metal particle 1 are not particularly limited. For example, it can be measured by observing the cross section of the soft magnetic metal particle 1 using various electron microscopes. Also, regarding the soft magnetic metal powder including the soft magnetic metal particles, for calculating an average thickness of each part, the thickness of each part is measured from at least 10 soft magnetic metal particles, and then the average may be calculated.

### (Covering Part 10)

The soft magnetic metal particle 1 according to the present embodiment includes the covering part 10 which contacts the surface of the core part 2. As show in FIG. 1, the covering part 10 may include a plurality of layers. The covering part 10 at least includes the C-concentrated part 12. The C-concentrated part 12 refers to a layer having a higher concentration of C than in the core part 2. The value obtained by subtracting the concentration of C (unit: at %) in the core part 2 from the concentration of C (unit: at %) in the C-concentrated part 12 may be 0.1 or greater, or may be 0.5 or greater. A thickness of the C-concentrated part 12 is not particularly limited. For example, it may be 0.5 nm or thicker and 50.0 nm or thinner. It may be 0.5 nm or thicker and 10.0 nm or thinner, and it may be 0.5 nm or thicker and 3.0 nm or thinner.

An average thickness of the C-concentrated part 12 in one soft magnetic metal particle 1 may be 0.5 nm or thicker and 50.0 nm or thinner. It may be between 0.5 nm or thicker and 10.0 nm or thinner, and it may be 0.5 nm or thicker and 3.0 nm or thinner.

An average thickness of the C-concentrated part 12 in the soft magnetic metal powder including a plurality of soft magnetic metal particles 1 may be 0.5 nm or thicker and 50.0 nm or thinner. It may be 0.5 nm or thicker and 10.0 nm or thinner, and it may be 0.5 nm or thicker and 3.0 nm or thinner.

By having the C-concentrated part 12 in the covering part 10 of the soft magnetic metal particle 1, it is possible to reduce the variation in the withstand voltage of the magnetic core manufactured using the soft magnetic metal powder including the soft magnetic metal particle 1. The reason for the reduced variation in the withstand voltage of the magnetic core when the soft magnetic metal powder has such configuration is not necessarily clear. When the soft magnetic metal powder satisfies the above-mentioned configuration, a compression degree of the soft magnetic metal powder can be reduced which improves the fluidity. Thus, it is thought that this enables to reduce the variation in the withstand voltage of the magnetic core.

A content ratio of the soft magnetic metal particle having the C-concentrated part 12 with respect to the entire soft magnetic metal particles included in the soft magnetic metal powder is not particularly limited. The content ratio may be at least 1 mas % or greater. Also, a content ratio of the soft magnetic metal particle having the C-concentrated part 12 in the magnetic core including the soft magnetic metal powder is not particularly limited. For example, when the magnetic core including the soft magnetic metal powder is cut at an arbitrary cross-section, the obtained cross-section may contain one or more particles including the C-concentrated part.

The thickness of the C-concentrated part 12 included in one soft magnetic metal particle 1 does not necessarily have to be even. That is, the thickness of the C-concentrated part 12 may be uneven and may vary. Also, the soft magnetic metal particle 1 may partially have an area where the C-concentrated part 12 is not formed. The C-concentrated part 12 may directly or indirectly cover 50% or greater of the surface of the core part 2. The C-concentrated part 12 included in one soft magnetic metal particle 1 may have a thickness as even as possible.

For example, in the cross section of one soft magnetic metal particle 1, an arithmetic mean height Ra of an outline curve on the surface of the C-concentrated part 12 may be 0.5 nm or thicker and 100 nm or thinner. In order to calculate Ra, for example, it may be calculated according to methods defined in JIS B601.

Regarding the magnetic core or the soft magnetic metal powder including the plurality of soft magnetic metal particles 1, Ra of at least ten soft magnetic metal particles 1 are calculated and the average thereof is obtained. Thereby, Ra of the soft magnetic metal powder or the magnetic core can be calculated.

Methods for evaluating the variation in the withstand voltage are not particularly limited. Below describes an evaluation method using a Weibull method as one example of method for evaluating the variation in the withstand voltage.

According to a Weibull distribution, a failure rate A (t) with respect to a time (t) can be represented by a below shown equation (I). In the equation (I), “m” is called a Weibull modulus, and “a” is called a scale parameter.

λ(t)=(m/α^{m})×t^{m-1} Equation (I)

Here, when m<1, the equation (I) shows that the failure rate decreases over time. When m=1, the equation (I) shows that the failure rate is consistent over time. When m>1, the equation (I) shows that the failure rate increases over time. Below describes a method for calculating the Weibull modulus m.

A reliability R(t) (a probability of not having failure) of the product having the above-mentioned failure rate λ(t) may be represented by the below equation (II).

R(t)=exp{−(t/α)^{m}} Equation (II)

Further, an unreliability (cumulative failure rate) F(t) may be represented by the below equation (III).

F(t)=1−R(t)=1−exp{−(t/a)^{m}} Equation (III)

Here, the equation (III) can be re-written as the below equation (IV).

ln[ln{1/(1−F(t))}]=mlnt−mlnα Equation (IV)

Here, when y=ln[ln{1/(1−F(t))}] and x=Int, the below equation (V) is satisfied.

y=mx−mlnα Equation (V)

That is, when y=ln[ln{1/(1−F(t))}] is plotted against x=Int, a straight line is obtained, and the Weibull modulus m can be calculated from a slope of the straight line. This method is called a Weibull plot.

In the case that m>1, the larger the Weibull modulus m, the steeper the increase of the unreliability (cumulative failure rate) F(t) is around a given time t. That is, the larger the Weibull modulus m, the smaller the variation in the time for each of the products to fail.

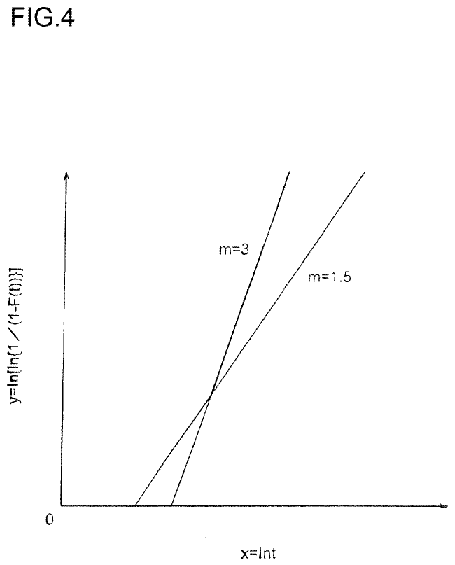

FIG. 4 is an example showing a schematic view of a Weibull plot. In FIG. 4, when m=3, the increase of F(t) becomes steeper around a given time t compared to the case of m=1.5. That is, when m is large, many products fail all at once around a given time t, i.e., the variation in the time for the products to fail are small. Note that, in the Weibull plot, the more the straight line moves to the right, the longer the time is for the products to fail.

The Weibull modulus m can be obtained by measuring the withstand voltages of the plurality of magnetic cores and then by performing the Weibull plot of the measurement results. When a predetermined current flows by applying voltage to the magnetic core, the applied voltage is deemed the withstand voltage. Further, the Weibull plot can be obtained using the above-mentioned “time t” as “an applied voltage V per unit length”, and the above-mentioned “failure” as “a predetermined current flows”. Methods for Weibull plotting are not particularly limited. Other than the method of calculating m by plotting the test results on a Weibull probability sheet, in recent years, computer program calculating the Weibull modulus m is widely used which automatically performs Weibull plot by inputting the test results.

As discussed in above, in the case that the variation in the withstand voltage are evaluated using the Weibull distribution, the larger the Weibull modulus m, the smaller the variation in the withstand voltage.

In terms of number of atoms, the local maximum (C(LM)) of the concentration of C in the C-concentrated part 12 may be ten times or greater than the concentration of C in the soft magnetic metal powder (C(P)). Due to the high local maximum of the concentration of C in the C-concentrated part 12, the variation in the withstand voltage tends to become even smaller. Any method can be used for calculating the local maximum of the concentration of C. For example, it can be calculated by observing the cross section of the soft magnetic metal particle 1 using STEM-EDS. Note that, this local maximum (local value) may be read as a maximum (maximum value).

Types and concentrations of components included in the soft magnetic metal particle and in each part of the soft magnetic metal particle such as the C-concentrated part can be identified from information obtained, for example, from an element analysis by Energy Dispersive X-ray Spectroscopy (EDS) using Scanning Transmission Electron Microscope (STEM); an element analysis by Electron Energy Loss Spectroscopy (EELS) using STEM or so.

The composition of the soft magnetic metal particle 1 may be analyzed using 3DAP (three-dimensional atom probe). In the case of using 3DAP, a small area (e.g., Φ20 nm×100 nm) including the C-concentrated part 12 is set inside the soft magnetic metal particle which is an object to be measured, and then an average composition of the C-concentrated part 12 can be measured. That is, in the case that the soft magnetic metal particle is included in the magnetic core, the composition of the soft magnetic metal particle itself can be identified by excluding the influence of the resin component included in the magnetic core and also the oxidation of the surface of the soft magnetic metal particle.

A concentration distribution of each element near the surface of the soft magnetic metal particle 1 can be measured, for example, along a perpendicular direction to the outermost surface of the soft magnetic metal particle 1 using STEM and EDS. Then, the obtained results are plotted on a graph; thereby, the local maximum of the concentration of C can be obtained. The number of observation areas in one soft magnetic metal particle 1 is not particularly limited. The number of observation areas may be one area or two or more areas in one soft magnetic metal particle 1. Further, the number of soft magnetic metal particles to be observed is not particularly limited. For example, five or more soft magnetic metal particles may be randomly selected from the soft magnetic metal powder and observed, or twenty or more soft magnetic metal particles may be randomly selected and observed.

The position of the oxide part 11 included in the covering part 10 may be identified based on a concentration of O in the soft magnetic metal particle 1 and a concentration of O in the covering part 10. For example, first, an average concentration of O in the soft magnetic metal particle 1 is calculated. Then, among the covering part 10, an area having higher average concentration of O in the soft magnetic metal particle 1 than the concentration of O near the surface of the soft magnetic metal particle 1 may be deemed the oxide part 11.

Methods for measuring the composition of the C-concentrated part 12 are not particularly limited. For example, an EDX device or EPMA attached to an electron microscope can be used for analysis.

The covering part 10 of the soft magnetic metal particle 1 according to the present embodiment may include, in addition to the C-concentrated part 12, the oxide part 11 contacting the surface of the core part 2. In the case that the soft magnetic metal particle 1 includes the oxide part 11, it is possible to further improve the withstand voltage and to further reduce the variation in the withstand voltage.

The composition of the oxide part 11 is not particularly limited. For example, the oxide part 11 may include an oxide of element included in the core part 2. This oxide may be a simple oxide or a composite oxide.

A thickness of the oxide part 11 is not particularly limited. For example, it may be 0.5 nm or thicker and 200 nm or thinner.

An average thickness of the oxide part 11 in one soft magnetic metal particle 1 may be 0.5 nm or thicker and 200 nm or thinner.

An average thickness of the oxide part 11 in the soft magnetic metal powder including a plurality of soft magnetic metal particles 1 may be 0.5 nm or thicker and 200 nm or thinner.

The thickness of the oxide part 11 included in one soft magnetic metal particle 1 does not necessarily have to be even. That is, the thickness of the oxide part 11 may be uneven and may vary. Also, the soft magnetic metal particle 1 may partially have an area where the oxide part 11 is not formed. The oxide part 11 may cover 50% or greater of the surface of the core part 2. The oxide part 11 included in one soft magnetic metal particle 1 may have a thickness as even as possible.

The covering part 10 of the soft magnetic metal particle 1 according to the present embodiment may include, in addition to the C-concentrated part 12, the outer coating part 13 contacting the surface of the C-concentrated part 12. A composition of the outer coating part 13 is not particularly limited. For example, the outer coating part 13 may be formed using a glass coating which is normally conducted in the technical field of the present disclosure. For example, the outer coating part 13 may include a phosphate glass or a silica glass.

In the case that the soft magnetic metal particle 1 includes the outer coating part 13, it is possible to further improve the withstand voltage and to further reduce the variation in the withstand voltage.

The thickness of the outer coating part 13 included in one soft magnetic metal particle 1 does not necessarily have to be even. That is, the thickness of the outer coating part 13 may be uneven and may vary. Also, the soft magnetic metal particle 1 may partially have an area where the outer coating part 13 is not formed. The outer coating part 13 may directly or indirectly cover 50% or greater of the surface of the core part 2. The outer coating part 13 included in one soft magnetic metal particle 1 may have a thickness as even as possible.

The C-concentrated part 12 has a conductive property. Regardless of the conductivity of the C-concentrated part 12, the magnetic core manufactured using the soft magnetic metal powder including the soft magnetic metal particle 1 having the C-concentrated part 12 does not lower the withstand voltage and reduces the variation in the withstand voltage compared to the magnetic core manufactured using the soft magnetic metal powder which does not include the soft magnetic metal particle 1 having the C-concentrated part 12.

In the case that the soft magnetic metal particle 1 has the C-concentrated part 12 at the outermost side, the soft magnetic metal powder including the soft magnetic metal particle 1 having the C-concentrated part 12 achieves a relatively improved fluidity. Therefore, when pressure is applied during the manufacturing of the magnetic core, the soft magnetic metal particles 1 easily move around. In addition, the surface condition of the soft magnetic metal particle 1 is improved, and this prevents electric field from locally concentrating. Thus, it is thought that the withstand voltage does not decrease and the variation in the withstand voltage is reduced.

Also, in the case that the soft magnetic metal particle 1 includes the outer coating part 13 at the outside of the C-concentrated part 12, due to carbon positioned on the surface of the soft magnetic metal particle 1 prior to forming the outer coating part 13, the soft magnetic metal powder including the soft magnetic metal particle 1 before forming the outer coating part 13 has a high fluidity. Therefore, when the outer coating part 13 is formed, the outer coating part 13 can be formed more evenly. Thus, it is thought that the variation in the withstand voltage becomes smaller.

Hereinafter, a method of manufacturing the soft magnetic metal powder according to the present embodiment will be described.

First, the soft magnetic metal powder including the soft magnetic metal particle which mainly becomes the core part 2 at the end is prepared. A method for preparing the soft magnetic metal powder is not particularly limited. For example, a commercially available soft magnetic metal powder may be prepared, or the soft magnetic metal powder may be made using atomization methods such as a water atomization method and a gas atomization method.

Whether the soft magnetic metal powder obtained using the atomization method has the amorphous structure or the crystal structure is primarily determined by the composition of the soft magnetic metal powder.

In the case that the soft magnetic metal powder obtained using the atomization method has the amorphous structure, nanocrystals having the crystal size of 5 nm or greater and 50 nm or less may precipitate by conducting a heat treatment, in that case, the soft magnetic metal powder having the nanocrystal structure can be obtained. It also depends primarily on the composition of the soft magnetic metal powder whether the nanocrystals can be precipitated by the heat treatment.

For example, the conditions of the heat treatment are a temperature of 350° C. or higher and 800° C. or lower for 1 minute or longer and 300 minutes or less. Note that, one soft magnetic metal particle normally includes a number of nanocrystals. That is, the particle size of the soft magnetic metal particle and the crystal size of the nanocrystal are different. Also, the crystal structure of the soft magnetic metal powder can be verified using XRD or a transmission electron microscope. In the case that the soft magnetic metal powder includes the nanocrystals, Hc of the magnetic core obtained at the end tends to be lower and the relative permeability tends to be higher.

The average particle size of the soft magnetic metal powder can be adjusted by changing the conditions of the atomization method. Also, the average particle size of the soft magnetic metal powder can be adjusted using classification. Also, the average particle size may be adjusted by blending a plurality of types of soft magnetic metal powders having different average particle sizes.

Next, the covering part of the soft magnetic metal particle included in the soft magnetic metal powder is formed.

In the case of forming the oxide part on the surface of the core part, any method may be used for forming the oxide part. For example, the surface of the soft magnetic metal particle may be oxidized by performing the heat treatment under the atmosphere including oxygen. The oxygen concentration in the atmosphere is not particularly limited. For example, it may be 1 ppm to 20000 ppm. The heat treatment temperature is not particularly limited. For example, it may be 150° C. to 800° C. The heat treatment time is not particularly limited. For example, it may be 0.1 hour to 10 hours. The higher the oxygen concentration, the higher the heat treatment temperature, and the longer the heat treatment time, the thicker the oxygen part tends to be.

A method for forming the C-concentrated part is described.

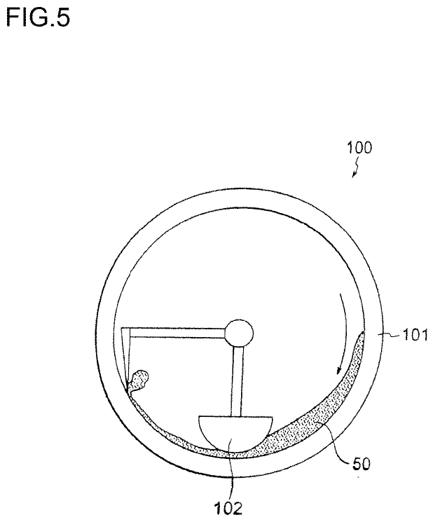

Any method may be used for forming the C-concentrated part. For example, the C-concentrated part may be formed using a mechanical ironing method which uses a powder coating device 100 shown in FIG. 5.

First, together with the soft magnetic metal powder to which the C-concentrated part is to be formed, a carbon powder is introduced in the powder coating device 100 shown in FIG. 5. The soft magnetic metal powder and the carbon powder are mixed to give a mixture 50. In such state, a rotor 101 is rotated, and the mixture 50 is compressed between a press-head 102 and an inner wall of the rotor 101 and heat is generated due to friction. Due to this friction heat, the carbon powder is softened, and the carbon adheres on the surface of the core part (in the case of forming the oxide part, carbon adheres on the surface of the oxide part) due to the compression effect; thereby, the C-concentrated part is formed.

An average particle size of the carbon powder is not particularly limited. The average particle size of the carbon powder may be roughly 1/10 or smaller than the average particle size of the soft magnetic metal powder. The atmosphere inside the powder coating device 100 is not particularly limited. For example, it may be inert atmosphere (e.g., Ar atmosphere). Also, the oxygen concentration in the atmosphere may be 1 to 20000 ppm. An added amount of the carbon powder is not particularly limited. For example, the added amount of carbon powder may be 0.01 to 10 parts by mass with respect to 100 parts by mass of the soft magnetic metal powder. The larger the added amount of the carbon powder, the thicker the C-concentrated part tends to be. A coating time is not particularly limited. For example, it may be 0.5 to and 10 hours. A temperature of the mixture is not particularly limited.

Any coating method may be used in the case of forming the outer coating part, and methods normally used in the technical field of the present disclosure may be used.

For example, dry coating may be conducted. In such case, materials of the outer coating part are not particularly limited. For example, the outer coating part made of a phosphate-based glass may be formed. In this case, using the above-mentioned powder coating device 100, the phosphate-based glass powder may be mixed to the soft magnetic metal powder having the C-concentrated part to form the mixture 50.

For example, wet coating may be also conducted. In such case, materials of the outer coating part are not particularly limited. For example, the outer coating part made of an oxide including Si may be formed by a sol-gel method using TEOS.

Since the fluidity of the powder is improved due to the C-concentrated part 12, the outer coating part 13 tends to be formed evenly.

The magnetic powder used for forming the magnetic core is not particularly limited. The above-mentioned soft magnetic metal powder may be used as the magnetic powder, or another powder may be blended with the above-mentioned iron-based soft magnetic metal powder to form the magnetic powder.

The obtained magnetic powder is molded to give the magnetic core. Any method of molding may be used as the molding method. A method of obtaining the magnetic core using pressure-molding is explained as one example.

First, the magnetic powder and the resin are mixed. Mixing the powder with the resin makes it easier to give a molded body having high strength by molding. Types of the resin are not limited. Examples of the resin include a phenol resin and an epoxy resin. The amount of the resin is not limited. When the resin is added, 1 mass % or more and 5 mass % or less of the resin may be added with respect to the magnetic powder.

A mixture of the soft magnetic metal powder and the resin is granulated to give a granulated powder. Any method of granulation may be used. For example, a stirrer may be used for granulation. The granulated powder may have any particle size.

The granulated powder is press molded to give the molded body. The press molding pressure is not limited. For example, a surface pressure may be 0.1 ton/cm² or greater and 10 ton/cm² or less. The higher the pressure for pressure molding, the higher the relative permeability. However, in the case that the magnetic powder has a broad particle size distribution, a high relative permeability can be obtained even when the pressure for pressure molding is lowered than a normal molding pressure. This is because the obtained magnetic core tends to be densified easily.

Then, the resin included in the molded body is cured, and thereby, the magnetic core can be obtained. Any curing method may be used, and a heat treatment may be conducted under the conditions that can cure the resin.

The magnetic core may be used for any purpose. For example, the magnetic core can be suitably used as a magnetic core for an inductor, particularly for a power inductor. Moreover, the magnetic core can be suitably used also for an inductor which is obtained by integrally molding the magnetic core and a coil.

Further, the above-mentioned magnetic core and a magnetic component using the above-mentioned magnetic core can be used for various electronic devices.

In particular, because the above-mentioned magnetic core has a high withstand voltage and has a small variation in the withstand voltage, the magnetic core is suitably used in fields in need of smaller size, lighter weight, and higher efficiency. For example, the above-mentioned magnetic core can be used for a magnetic core, a magnetic component, and an electronic device mounted on hybrid-vehicles, plug-in hybrid-vehicles, and electric vehicles.

### EXAMPLES

Below describes the present disclosure in detail based on examples.

### Experiment Example 1

A soft magnetic metal powder having a type of composition as shown in a column of “Core part composition” in Table 1 was formed. Specifically, ingots of various materials were prepared and weighed to obtain a molten metal having a target composition. Next, a chamber was vacuumed, and a crucible was heated by high-frequency induction using a work coil provided outside of the crucible to melt and mix the raw materials to give a molten metal (molten) having a temperature of 1400° C. to 1600° C.

The obtained molten was supplied in a form of a linear continuous fluid into the chamber through a nozzle provided on a bottom of the crucible, and a gas was sprayed to the supplied molten; thereby, a powder was obtained. A spraying temperature of gas was 20° C.

For Sample Nos. 5 and 6, the obtained powder was subjected to a heat treatment under inert atmosphere at 550° C. for 60 minutes.

The obtained powder was classified using a sieve. An average particle size of the powder was adjusted to about 25 μm through classification.

An ICP analysis was used to confirm that the composition of the molten metal and the composition of the soft magnetic metal powder were about the same. Note that, the compositions of Sample Nos. 1 and 2 were 88.0Fe-12.0Si. The compositions of Sample Nos. 3 and 4 were 72.7Fe-11.6Si-10.8B-2.2Cr-2.7C. The compositions of Sample Nos. 5 and 6 were 73.5Fe-13.5Si-9.0B-3.0Nb-1.0Cu. In the present examples, the compositions are all shown in terms of atomic ratio.

A microstructure of each soft magnetic metal powder was verified using XRD. It was verified that Sample Nos. 1 and 2 had a crystal structure, Sample Nos. 3 and 4 had an amorphous structure, and Sample Nos. 5 and 6 had a nanocrystal structure. In each table shown in below, a sample indicated “crystal” in the column of microstructure means that the sample had a crystal structure. A sample indicated “amorphous” means that the sample had an amorphous structure. A sample indicated “nanocrystal” means that the sample had a nanocrystal structure.

Next, a C-concentrated part was formed to the obtained powder. Note that, the powder indicated “0” in the column showing the average thickness of the C-concentrated part means that the C-concentrated part was not formed.

In order to form the C-concentrated part on the surface of the soft magnetic metal powder, a carbon powder and the soft magnetic metal powder were introduced in a powder coating device shown in FIG. 5. The atmosphere inside the powder coating device was inert atmosphere (Ar atmosphere). The average particle size of the carbon powder was adjusted to be 1/10 or smaller than the average particle size of the soft magnetic metal powder. The added amount of the carbon powder was controlled accordingly so that the average thickness of the C-concentrated part in the soft magnetic metal powder at the end satisfied the value shown in each table. Specifically, the added amount of carbon powder was between 0.1 to 3 parts by mass with respect to 100 parts by mass of the soft magnetic metal powder. Also, a coating time was 0.5 to 3 hours. Further, the average thickness of the C-concentrated part measured using a later-described method was adjusted so that it was the value shown in Table 1.

It was confirmed that all of the examples had a concentration of C in the C-concentrated part of 80 at % or greater. Also, in addition to C, the C-concentrated part may include oxygen and elements which were included the core part. It was confirmed that all of the examples had a concentration of C in the C-concentrated part higher than the concentration of C in the core part.

The thickness of the C-concentrated part of the soft magnetic metal powder included in the soft magnetic metal powder was calculated by observing the cross section of the soft magnetic metal particle using STEM. Also, for the average thickness of the C-concentrated part in the soft magnetic metal powder of the examples and the comparative examples, the thicknesses of the C-concentrated parts of at least ten soft magnetic metal particles were measured, and the average was calculated. Thereby, the average thickness of the C-concentrated part was obtained. Also, it was confirmed that the soft magnetic metal particle included in the soft magnetic metal powder of each example had the C-concentrated part having an arithmetic mean height Ra of 0.5 nm or greater and 100 nm or less.

Next, a cylinder-shaped core was made using the obtained soft magnetic metal powder.

The soft magnetic metal powder and the resin (phenol resin) were mixed. The resin was adjusted to be 3 mass % after mixing. Next, a generally used planetary mixer was used as a stirrer to obtain the granulated powder having a particle size of about 500 μm. Next, the obtained granulated powder was press-molded at a surface pressure of 4 ton/cm²; and thereby, a cylinder-shaped molded body having a diameter of 8.0 mmφ and a height of 8.0 mm was obtained. The obtained molded body was cured at 150° C. to form a cylinder-shaped core.

For each sample, twenty cylinder-shaped cores were formed. For each cylinder-shaped core, In—Ga electrodes were formed to two surfaces perpendicular to a thickness direction. Next, voltage was applied to the cylinder-shaped core using a source meter (THK-2011ADMPT made by TAMADENSOKU CO., LTD.), and the voltage was measured when the flowing current was 10 mA flowed. Then, the measured voltage was divided by the thickness of the cylinder-shaped core; thereby, the withstand voltage of the cylinder-shaped core was measured. An average was calculated from the withstand voltages of twenty cylinder-shaped cores, and the obtained average was deemed the withstand voltage of each sample. Further, a Weibull plot of the withstand voltages of the twenty cylinder-shaped cores were conducted, and a m-value of each sample was calculated. The m-value of 4.0 or greater was deemed favorable, and 5.5 or greater was deemed more favorable.

TABLE 1

| | | | | | Ave. | | |
|---|---|---|---|---|---|---|---|
| | | | | | thickness of | | |
| | | | | | C- | | |
| | Example/ | | | | concentrated | Withstand | |
| Sample | Comparative | Core part | | | part | voltage | m- |
| No. | example | composition | Microstructure | Oxide | (nm) | (V/mm) | value |
| 1 | Comparative | Fe—Si-based | Crystal | None | 0 | 110 | 2.8 |
| 2 | Example | Fe—Si-based | Crystal | None | 10 | 120 | 4.4 |
| 3 | Comparative | Fe—Si—B—Cr—C-based | Amorphous | None | 0 | 80 | 2.2 |
| | example | | | | | | |
| 4 | Example | Fe—Si—B—Cr—C-based | Amorphous | None | 10 | 110 | 5.8 |
| 5 | Comparative | Fe—Si—B—Nb—Cu-based | Nanocrystal | None | 0 | 90 | 3.1 |
| | example | | | | | | |
| 6 | Example | Fe—Si—B—Nb—Cu-based | Nanocrystal | None | 9 | 110 | 8.0 |

According to Table 1, the soft magnetic metal powder having the C-concentrated part as the covering part exhibited improved withstand voltage and m-value compared to the soft magnetic metal powder made under the same conditions except for not having C-concentrated part as the covering part. It is thought that the withstand voltage and the m-value were improved because areas where the electric field concentrate were reduced due to the formation of the C-concentrated part.

### Experiment Example 2

Experiment example 2 was conducted under the same conditions as in the case of Sample Nos. 2, 4, and 6, except that the oxide part was formed on the surface of the soft magnetic metal powder before forming the C-concentrated part. Specifically, each soft magnetic metal powder was heat treated at a temperature of 300° C. under the atmosphere having an oxygen concentration of 10 to 10000 ppm for one hour. A thickness of the oxide part was adjusted by changing the oxygen concentration. An average thickness of the oxide part of the heat treated soft magnetic metal powder was measured. Results are shown in Table 2.

TABLE 2

| | | | | | Ave. thickness | | |
|---|---|---|---|---|---|---|---|
| | | | | | of C- | | |
| | Example/ | | | Oxide | concentrated | Withstand | |
| Sample | Comparative | | | part | part | voltage | m- |
| No | example | Core part composition | Microstructure | (nm) | (nm) | (V/mm) | value |
| 2 | Example | Fe—Si-based | Crystal | 0 | 10 | 120 | 4.4 |
| 2a | Example | Fe—Si-based | Crystal | 0.3 | 9 | 160 | 4.8 |
| 2b | Example | Fe—Si-based | Crystal | 0.5 | 9 | 170 | 4.9 |
| 11 | Example | Fe—Si-based | Crystal | 10 | 9 | 180 | 4.9 |
| 11a | Example | Fe—Si-based | Crystal | 50 | 9 | 180 | 5.0 |
| 11b | Example | Fe—Si-based | Crystal | 200 | 9 | 180 | 4.9 |
| 11c | Example | Fe—Si-based | Crystal | 300 | 9 | 180 | 4.9 |
| 4 | Example | Fe—Si—B—Cr—C-based | Amorphous | 0 | 10 | 110 | 5.8 |
| 4a | Example | Fe—Si—B—Cr—C-based | Amorphous | 0.3 | 10 | 160 | 6.1 |
| 4b | Example | Fe—Si—B—Cr—C-based | Amorphous | 0.5 | 10 | 170 | 6.2 |
| 12 | Example | Fe—Si—B—Cr—C-based | Amorphous | 10 | 10 | 190 | 6.2 |
| 12a | Example | Fe—Si—B—Cr—C-based | Amorphous | 50 | 10 | 190 | 6.2 |
| 12b | Example | Fe—Si—B—Cr—C-based | Amorphous | 200 | 10 | 190 | 6.2 |
| 12c | Example | Fe—Si—B—Cr—C-based | Amorphous | 300 | 10 | 190 | 6.3 |
| 6 | Example | Fe—Si—B—Nb—Cu-based | Nanocrystal | 0 | 9 | 110 | 8.0 |
| 6a | Example | Fe—Si—B—Nb—Cu-based | Nanocrystal | 0.3 | 11 | 150 | 8.3 |
| 6b | Example | Fe—Si—B—Nb—Cu-based | Nanocrystal | 0.5 | 11 | 160 | 8.4 |
| 13 | Example | Fe—Si—B—Nb—Cu-based | Nanocrystal | 10 | 11 | 180 | 8.4 |
| 13a | Example | Fe—Si—B—Nb—Cu-based | Nanocrystal | 50 | 11 | 180 | 8.5 |
| 13b | Example | Fe—Si—B—Nb—Cu-based | Nanocrystal | 200 | 11 | 180 | 8.4 |
| 13c | Example | Fe—Si—B—Nb—Cu-based | Nanocrystal | 300 | 11 | 180 | 8.5 |

According to Table 2, the examples having the oxide part exhibited improved withstand voltage and m-value compared to the examples which was conducted under the same conditions except for not having the oxide part.

### Experiment Example 3

### (Sample Nos. 21 to 24)

Experiment example 3 was conducted under the same conditions as Sample No. 12 except that the oxygen concentration inside the atmosphere of the powder coating device was increased. Specifically, the oxygen concentration was varied within the range of 0 to 10000 ppm. Then, for each sample, C(LM) was measured to calculate C(LM)/C(P). Results are shown in Table 3.

### (Sample Nos. 25 to 28)

Sample Nos. 25 to 28 were conducted under the same conditions as Sample Nos. 12 and 21 to 24, except that the composition of the soft magnetic metal powder was changed to 75.3Fe-11.6Si-10.8B-2.2Cr-0.1C and the oxygen concentration inside the powder coating device was controlled so that C(LM) did not change. Results are shown in Table 3.

TABLE 3

| | | | | Ave. thickness | | | | | |
|---|---|---|---|---|---|---|---|---|---|
| | | | | of C- | | | | | |
| | Example/ | | | concentrated | | | | Withstand | |
| Sample | Comparative | | Oxide | part | C(LM) | C(P) | C(LM)/ | voltage | m- |
| No. | example | Structure | part | (nm) | (at %) | (at %) | C(P) | (V/mm) | value |
| 12 | Example | Amorphous | Formed | 10 | 96 | 2.7 | 36 | 190 | 5.9 |
| 21 | Example | Amorphous | Formed | 9 | 50 | 2.7 | 19 | 190 | 5.7 |
| 22 | Example | Amorphous | Formed | 10 | 27 | 2.7 | 10 | 180 | 5.8 |
| 23 | Example | Amorphous | Formed | 10 | 20 | 2.7 | 7 | 180 | 4.3 |
| 24 | Example | Amorphous | Formed | 11 | 10 | 2.7 | 4 | 170 | 4.2 |
| 25 | Example | Amorphous | Formed | 9 | 96 | 0.1 | 960 | 190 | 5.9 |
| 26 | Example | Amorphous | Formed | 10 | 50 | 0.1 | 500 | 190 | 5.8 |
| 27 | Example | Amorphous | Formed | 11 | 31 | 0.1 | 310 | 180 | 5.9 |
| 28 | Example | Amorphous | Formed | 9 | 10 | 0.1 | 102 | 180 | 5.8 |

The C-concentrated parts of the samples shown in Table 3 had the thicknesses in the range of 9 to 11 nm.

According to Table 3, the examples having C(LM)/C(P) of 10 or greater exhibited an improved m-value compared to the examples having C(LM)/C(P) of less than 10.

Except for Experiment example 3, the examples shown in the experiment examples exhibited C(LM)/C(P) of 10 or greater unless mentioned otherwise.

### Experiment Example 4

Experiment example 4 was conducted under the same conditions as Sample No. 12 except that the average thickness of the C-concentrated part was changed by changing the amount of a carbon powder introduced in the powder coating device. Results are shown in Table 4. Note that, the results of Sample Nos. 3 and 4 are shown in Table 4 for reference.

TABLE 4

| | | | | Ave. thickness of | | |
|---|---|---|---|---|---|---|
| | Example/ | | | C-concentrated | Withstand | |
| Sample | Comparative | | Oxide | part | voltage | |
| No. | example | Structure | part | (nm) | (V/mm) | m-value |
| 3 | Comparative | Amorphous | None | 0 | 80 | 2.2 |
| | example | | | | | |
| 4 | Example | Amorphous | None | 10 | 110 | 5.8 |
| 31 | Comparative | Amorphous | Formed | 0 | 180 | 2.2 |
| | example | | | | | |
| 32 | Example | Amorphous | Formed | 0.3 | 180 | 4.4 |
| 33 | Example | Amorphous | Formed | 0.5 | 190 | 6.1 |
| 34 | Example | Amorphous | Formed | 3 | 190 | 6.2 |
| 35 | Example | Amorphous | Formed | 5 | 180 | 5.9 |
| 12 | Example | Amorphous | Formed | 10 | 190 | 5.9 |
| 36 | Example | Amorphous | Formed | 25 | 180 | 5.7 |
| 37 | Example | Amorphous | Formed | 50 | 180 | 5.6 |
| 38 | Example | Amorphous | Formed | 75 | 180 | 5.4 |

According to Table 4, Sample Nos. 12 and 33 to 37, which the average thicknesses of the C-concentrated parts varied in the range of 0.5 nm to 50 nm, exhibited an excellent m-value compared to Sample Nos. 32 and 38, which the average thicknesses of the C-concentrated parts were outside of the above-mentioned range. In contrast, Sample No. 31 which did not have the C-concentrated part exhibited a lowered m-value.

### Experiment Example 5

In Experiment example 5, coating was conducted to a soft magnetic metal powder prior to coating as shown in Tables 5A to 5C to form an outer coating part; thereby, Sample Nos. 41 to 58 were formed.

### (Dry Coating (Phosphate Coating))

The soft magnetic metal powder and a phosphate-based glass (P—Zn—Al—O-based oxide glass) were together introduced into the powder coating device shown in FIG. 5. At this time, the amount of the phosphate-based glass was controlled so as to regulate the thickness of the outer coating part to be about 20 nm, and the outer coating part made of the phosphate-based glass was formed. Results are shown in Tables 5A to 5C.

### (Wet Coating (Si-Coating))

The outer coating part made of oxides including Si was formed by a sol-gel method using TEOS to the soft magnetic metal powder. At this time, the TEOS concentration was controlled so as to regulate the thickness of the outer coating part to be about 20 nm. Results are shown in Tables 5A to 5C.

TABLE 5A

| | | Sample | | | | Ave. thickness of | | | |
|---|---|---|---|---|---|---|---|---|---|
| | Example/ | No. | | | | C-concentrated | Outer | Withstand | |
| Sample | Comparative | before | Core part | Micro- | Oxide | part | coating | voltage | m- |
| No. | example | coating | composition | structure | part | (nm) | part | (V/mm) | value |
| 1 | Comparative | 1 | Fe—Si-based | Crystal | None | 0 | None | 110 | 2.8 |
| | example | | | | | | | | |
| 2 | Example | 2 | Fe—Si-based | Crystal | None | 10 | None | 120 | 4.4 |
| 11 | Example | 11 | Fe—Si-based | Crystal | Formed | 10 | None | 180 | 4.9 |
| 41 | Comparative | 1 | Fe—Si-based | Crystal | None | 0 | Phosphate | 250 | 2.2 |
| | example | | | | | | | | |
| 42 | Example | 2 | Fe—Si-based | Crystal | None | 10 | Phosphate | 260 | 5.8 |
| 43 | Example | 11 | Fe—Si-based | Crystal | Formed | 10 | Phosphate | 380 | 5.9 |
| 44 | Comparative | 1 | Fe—Si-based | Crystal | None | 0 | SiO₂ | 230 | 1.9 |
| | example | | | | | | | | |
| 45 | Example | 2 | Fe—Si-based | Crystal | None | 10 | SiO₂ | 310 | 4.9 |
| 46 | Example | 11 | Fe—Si-based | Crystal | Formed | 10 | SiO₂ | 340 | 5.2 |

TABLE 5B

| | | | | | | Ave. | | | |
|---|---|---|---|---|---|---|---|---|---|
| | | | | | | thick- | | | |
| | | | | | | ness | | | |
| | | | | | | of C- | | | |
| | | Sam- | | | | con- | | With- | |
| | | ple | | | | cen- | | stand | |
| Sam- | Example/ | No. | | | | trated | Outer | voltage | |
| ple | Comparative | before | Core part | Micro- | Oxide | part | coating | (V/ | m- |
| No. | example | coating | composition | structure | part | (nm) | part | mm) | value |
| 3 | Comparative | 3 | Fe—Si—B—Cr—C-based | Amorphous | None | 0 | None | 80 | 2.2 |
| | example | | | | | | | | |
| 4 | Example | 4 | Fe—Si—B—Cr—C-based | Amorphous | None | 10 | None | 110 | 5.8 |
| 12 | Example | 12 | Fe—Si—B—Cr—C-based | Amorphous | Formed | 10 | None | 190 | 5.9 |
| 47 | Comparative | 3 | Fe—Si—B—Cr—C-based | Amorphous | None | 0 | Phosphate | 400 | 3.5 |
| | example | | | | | | | | |
| 48 | Example | 4 | Fe—Si—B—Cr—C-based | Amorphous | None | 10 | Phosphate | 400 | 7.3 |
| 49 | Example | 12 | Fe—Si—B—Cr—C-based | Amorphous | Formed | 10 | Phosphate | 550 | 8.0 |
| 50 | Comparative | 3 | Fe—Si—B—Cr—C-based | Amorphous | None | 0 | SiO₂ | 380 | 3.2 |
| | example | | | | | | | | |
| 51 | Example | 4 | Fe—Si—B—Cr—C-based | Amorphous | None | 10 | SiO₂ | 390 | 5.9 |
| 52 | Example | 12 | Fe—Si—B—Cr—C-based | Amorphous | Formed | 10 | SiO₂ | 480 | 6.8 |

TABLE 5C

| | | | | | | Ave. | | | |
|---|---|---|---|---|---|---|---|---|---|
| | | | | | | thick- | | | |
| | | | | | | ness | | | |
| | | | | | | of C- | | With- | |
| | | Sam- | | | | con- | | stand | |
| | | ple | | | | cen- | | volt- | |
| Sam- | Example/ | No. | | | | trated | Outer | age | |
| ple | Comparative | before | | Micro- | Oxide | part | coating | (V/ | m- |
| No. | example | coating | Core part composition | structure | part | (nm) | part | mm) | value |
| 5 | Comparative | 5 | Fe—Si—B—Nb—Cu-based | Nanocrystal | None | 0 | None | 90 | 3.1 |
| | example | | | | | | | | |
| 6 | Example | 6 | Fe—Si—B—Nb—Cu-based | Nanocrystal | None | 10 | None | 110 | 8.0 |
| 13 | Example | 13 | Fe—Si—B—Nb—Cu-based | Nanocrystal | None | 10 | None | 180 | 8.4 |
| 53 | Comparative | 5 | Fe—Si—B—Nb—Cu-based | Nanocrystal | None | 0 | Phosphate | 350 | 3.3 |
| | example | | | | | | | | |
| 54 | Example | 6 | Fe—Si—B—Nb—Cu-based | Nanocrystal | None | 10 | Phosphate | 340 | 9.1 |
| 55 | Example | 13 | Fe—Si—B—Nb—Cu-based | Nanocrystal | Formed | 10 | Phosphate | 420 | 9.5 |
| 56 | Comparative | 5 | Fe—Si—B—Nb—Cu-based | Nanocrystal | None | 0 | SiO₂ | 310 | 3.1 |
| | example | | | | | | | | |
| 57 | Example | 6 | Fe—Si—B—Nb—Cu-based | Nanocrystal | None | 10 | SiO₂ | 310 | 8.7 |
| 58 | Example | 13 | Fe—Si—B—Nb—Cu-based | Nanocrystal | Formed | 10 | SiO₂ | 390 | 9.0 |

The examples which had the outer coating part contacting the surface of the C-concentrated part exhibited a significantly improved withstand voltage compared to the examples conducted under the sample conditions except for not having the outer coating part. Also, the withstand voltage and the m-value tended to improve when the coating (outer coating part) was formed using a dry coating compared to the case of forming the coating (outer coating part) using the wet coating.

### Experiment Example 6

Experiment example 6 was conducted under the same conditions as Sample No. 49 except that the average particle size of the soft magnetic metal powder was changed. Results are shown in Table 6.

TABLE 6

| | | | | Ave. | | | |
|---|---|---|---|---|---|---|---|
| | | | | thickness of | | | |
| | | | | C- | Ave. | | |
| | Example/ | | | concentrated | particle | Withstand | |
| Sample | Comparative | | | part | size | voltage | m- |
| No. | example | Microstructure | Oxide part | (nm) | (μm) | (V/mm) | value |
| 61 | Example | Amorphous | Formed | 10 | 1 | 1200 | 10.3 |
| 62 | Example | Amorphous | Formed | 10 | 3 | 900 | 9.9 |
| 63 | Example | Amorphous | Formed | 10 | 10 | 630 | 8.3 |
| 49 | Example | Amorphous | Formed | 10 | 25 | 550 | 8.0 |
| 64 | Example | Amorphous | Formed | 10 | 50 | 480 | 6.7 |

According to Table 6, the smaller the average particle size of the soft magnetic metal powder having small, the more improved the withstand voltage and the m-value tended to be.

### Experiment Example 7

In Experiment example 7, the soft magnetic metal powder of Sample No. 3 (the C-concentrated part not formed) and the soft magnetic metal powder of Sample No. 4 (the C-concentrated part formed) were mixed in a ratio as indicated in Table 7. Then, the outer coating part made of phosphate was formed using the similar method as in the case of Sample Nos. 47 and 48. Results are shown in Table 7.

TABLE 7

| | | Sample No. 3 | Sample No. 4 | | | | |
|---|---|---|---|---|---|---|---|
| | | (no C- | (C- | | | | |
| | Example/ | concentrated | concentrated | | Outer | Withstand | |
| Sample | Comparative | part) | part formed) | | coating | voltage | m- |
| No. | example | (wt %) | (wt %) | Microstructure | part | (V/mm) | value |
| 3 | Comparative | 100 | 0 | Amorphous | None | 80 | 2.2 |
| | example | | | | | | |
| 4a | Example | 99 | 1 | Amorphous | None | 100 | 4.1 |
| 4b | Example | 90 | 10 | Amorphous | None | 110 | 4.3 |
| 4c | Example | 50 | 50 | Amorphous | None | 110 | 4.9 |
| 4d | Example | 10 | 90 | Amorphous | None | 110 | 5.3 |
| 4e | Example | 1 | 99 | Amorphous | None | 110 | 5.6 |
| 4 | Example | 0 | 100 | Amorphous | None | 110 | 5.8 |
| 47 | Comparative | 100 | 0 | Amorphous | Phosphate | 400 | 3.5 |
| | example | | | | | | |
| 71 | Example | 99 | 1 | Amorphous | Phosphate | 400 | 5.1 |
| 72 | Example | 90 | 10 | Amorphous | Phosphate | 400 | 5.7 |
| 73 | Example | 50 | 50 | Amorphous | Phosphate | 400 | 6.1 |
| 74 | Example | 10 | 90 | Amorphous | Phosphate | 400 | 6.4 |
| 75 | Example | 1 | 99 | Amorphous | Phosphate | 400 | 7.1 |
| 48 | Example | 0 | 100 | Amorphous | Phosphate | 400 | 7.3 |

According to Table 7, it was confirmed that when the soft magnetic metal powder at least partially included the soft magnetic metal particle having the C-concentrated part, the effect of improving the m-value was observed. Further, the larger the ratio of the soft magnetic metal particle having the C-concentrated part, it was confirmed that the larger the effect of improving the m-value.

Note that, in the case of manufacturing the magnetic core such as a dust core using the powder shown in Table 7, the presence of the C-concentrated part in each particle was verified by observing the cross section of the magnetic core using STEM-EDX. That is, in order to verify the ratio of the soft magnetic metal particle having the C-concentrated part in the magnetic core, the ratio of the soft magnetic metal particle having the C-concentrated part in the cross section of the magnetic core may be observed.

### Experiment Example 8

In Experiment example 8, Sample Nos. 81 to 100 were made similarly to Sample Nos. 1 and 2 except for changing the composition (core part composition) of the soft magnetic metal powder. The compositions of the soft magnetic metal powders of Sample Nos. 81 and 82 substantially only included Fe. For Sample Nos. 83 and 84, the composition was adjusted so that an atomic ratio was 55.0Fe-45.0Ni. For Sample Nos. 85 and 86, the composition was adjusted so that an atomic ratio was 89.4Fe-8.6Si-2.0Cr. For Sample Nos. 87 and 88, the composition was adjusted so that an atomic ratio was 73.7Fe-16.4Si-9.9Al. For Sample Nos. 89 and 90, the composition was adjusted so that an atomic ratio was 78.1Fe-11.0Si-10.0Al-0.9Ni. For Sample Nos. 91 and 92, the composition was adjusted so that an atomic ratio was 49.2Fe-42.0Ni-4.0Si-4.8Co. For Sample Nos. 93 and 94, the composition was adjusted so that an atomic ratio was 50.0Fe-50.0Co. For Sample Nos. 95 and 96, the composition was adjusted so that an atomic ratio was 49.0Fe-49.0Co-2.0V. For Sample Nos. 97 and 98, the composition was adjusted so that an atomic ratio was 83.6Fe-4.4Co-12.0Si. For Sample Nos. 99 and 100, the composition was adjusted so that an atomic ratio was 66.3Fe-7.4Co-16.4Si-9.9Al. Results are shown in Table 8A. The C-concentrated parts of the examples shown in Table 8A had the thicknesses in the range of 8 to 12 nm. Comparative examples shown in Table 8A did not have the C-concentrated part.

Sample Nos. 111 to 122 were conducted similarly to Sample Nos. 3 and 4 except for changing the composition (core part composition) of the soft magnetic metal powder. For Sample Nos. 111 and 112, the composition was adjusted so that an atomic ratio was 81.6Fe-3.4Si-13.4B-1.6C. For Sample Nos. 113 and 114, the composition was adjusted so that an atomic ratio was 63.2Fe-15.8Co-10.0B-5.0P-5.0Si-1.0Cr. For Sample Nos. 115 and 116, the composition was adjusted so that an atomic ratio was 72.3Fe-18.2Si-9.5B. For Sample Nos. 117 and 118, the composition was adjusted so that an atomic ratio was 56.0Fe-24.0Co-15.0P-5.0C. For Sample Nos. 119 and 120, the composition was adjusted so that an atomic ratio was 56.0Fe-24.0Co-20.0B. For Sample Nos. 121 and 122, the composition was adjusted so that an atomic ratio was 56.0Fe-24.0Co-15.0B-5.0Si. Results are shown in Table 8B. The C-concentrated parts of the examples shown in Table 8B had the thicknesses in the range of 8 to 11 nm. Comparative examples shown in Table 8B did not have the C-concentrated part.

Sample Nos. 131 to 136 were conducted similarly to Sample Nos. 5 and 6 except for changing the composition (core part composition) of the soft magnetic metal powder. For Sample Nos. 131 and 132, the composition was adjusted so that an atomic ratio was 79.0Fe-1.0Si-10.0B-7.0Nb-3.0P. For Sample Nos. 133 and 134, the composition was adjusted so that an atomic ratio was 63.2Fe-15.8Co-11.0B-9.0P-1.0Si. For Sample Nos. 135 and 136, the composition was adjusted so that an atomic ratio was 63.2Fe-15.8Co-10.0B-5.0P-5.0Si-1.0Cr. Results are shown in Table 8C. The C-concentrated parts of the examples shown in Table 8C had the thicknesses in the range of 9 to 11 nm. Comparative examples shown in Table 8C did not have the C-concentrated part.

TABLE 8A

| | Example/ | | | | Withstand | |
|---|---|---|---|---|---|---|
| Sample | Comparative | Core part | Micro- | Oxide | voltage | m- |
| No. | example | composition | structure | part | (V/mm) | value |
| 1 | Comparative | Fe—Si-based | Crystal | None | 110 | 2.8 |
| | example | | | | | |
| 2 | Example | Fe—Si-based | Crystal | None | 120 | 4.4 |
| 81 | Comparative | Fe-based | Crystal | None | 110 | 2.2 |
| | example | | | | | |
| 82 | Example | Fe-based | Crystal | None | 110 | 4.1 |
| 83 | Comparative | Fe—Ni-based | Crystal | None | 120 | 2.3 |
| | example | | | | | |
| 84 | Example | Fe—Ni-based | Crystal | None | 120 | 4.2 |
| 85 | Comparative | Fe—Si—Cr-based | Crystal | None | 110 | 2.1 |
| | example | | | | | |
| 86 | Example | Fe—Si—Cr-based | Crystal | None | 110 | 4.5 |
| 87 | Comparative | Fe—Si—Al-based | Crystal | None | 110 | 2.1 |
| | example | | | | | |
| 88 | Example | Fe—Si—Al-based | Crystal | None | 110 | 4.6 |
| 89 | Comparative | Fe—Si—Al—Ni-based | Crystal | None | 120 | 2.3 |
| | example | | | | | |
| 90 | Example | Fe—Si—Al—Ni-based | Crystal | None | 120 | 4.3 |
| 91 | Comparative | Fe—Ni—Si—Co-based | Crystal | None | 130 | 2.3 |
| | example | | | | | |
| 92 | Example | Fe—Ni—Si—Co-based | Crystal | None | 130 | 5.1 |
| 93 | Comparative | Fe—Co-based | Crystal | None | 120 | 2.1 |
| | example | | | | | |
| 94 | Example | Fe—Co-based | Crystal | None | 120 | 5.1 |
| 95 | Comparative | Fe—Co—V-based | Crystal | None | 120 | 1.8 |
| | example | | | | | |
| 96 | Example | Fe—Co—V-based | Crystal | None | 120 | 4.9 |
| 97 | Comparative | Fe—Co—Si-based | Crystal | None | 120 | 2.1 |
| | example | | | | | |
| 98 | Example | Fe—Co—Si-based | Crystal | None | 120 | 5.1 |
| 99 | Comparative | Fe—Co—Si—Al-based | Crystal | None | 110 | 2.1 |
| | example | | | | | |
| 100 | Example | Fe—Co—Si—Al-based | Crystal | None | 110 | 5.2 |

TABLE 8B

| | Example/ | | | | Withstand | |
|---|---|---|---|---|---|---|
| Sample | Comparative | | | Oxide | voltage | m- |
| No. | example | Core part composition | Microstructure | part | (V/mm) | value |
| 3 | Comparative | Fe—Si—B—Cr—C-based | Amorphous | None | 80 | 2.2 |
| | example | | | | | |
| 4 | Example | Fe—Si—B—Cr—C-based | Amorphous | None | 110 | 5.8 |
| 111 | Comparative | Fe—Si—B—C-based | Amorphous | None | 80 | 2.3 |
| | example | | | | | |
| 112 | Example | Fe—Si—B—C-based | Amorphous | None | 120 | 5.9 |
| 113 | Comparative | Fe—Co—B—P—Si—Cr-based | Amorphous | None | 90 | 2.8 |
| | example | | | | | |
| 114 | Example | Fe—Co—B—P—Si—Cr-based | Amorphous | None | 120 | 6.9 |
| 115 | Comparative | Fe—Si—B-based | Amorphous | None | 80 | 2.2 |
| | example | | | | | |
| 116 | Example | Fe—Si—B-based | Amorphous | None | 110 | 5.9 |
| 117 | Comparative | Fe—Co—P—C-based | Amorphous | None | 90 | 2.1 |
| | example | | | | | |
| 118 | Example | Fe—Co—P—C-based | Amorphous | None | 110 | 7.3 |
| 119 | Comparative | Fe—Co—B-based | Amorphous | None | 90 | 2.3 |
| | example | | | | | |
| 120 | Example | Fe—Co—B-based | Amorphous | None | 110 | 7.3 |
| 121 | Comparative | Fe—Co—B—Si-based | Amorphous | None | 90 | 2.3 |
| | example | | | | | |
| 122 | Example | Fe—Co—B—Si-based | Amorphous | None | 120 | 7.4 |

TABLE 8C

| | Example/ | | | | Withstand | |
|---|---|---|---|---|---|---|
| Sample | Comparative | | | Oxide | voltage | m- |
| No. | example | Core part composition | Microstructure | part | (V/mm) | value |
| 5 | Comparative | Fe—Si—B—Nb—Cu-based | Nanocrystal | None | 90 | 3.1 |
| 6 | Example | Fe—Si—B—Nb—Cu-based | Nanocrystal | None | 110 | 8.0 |
| 131 | Comparative | Fe—Si—B—Nb—P-based | Nanocrystal | None | 90 | 2.8 |
| 132 | Example | Fe—Si—B—Nb—P-based | Nanocrystal | None | 110 | 6.1 |
| 133 | Comparative | Fe—Co—B—P—Si-based | Nanocrystal | None | 110 | 2.1 |
| 134 | Example | Fe—Co—B—P—Si-based | Nanocrystal | None | 130 | 9.2 |
| 135 | Comparative | Fe—Co—B—P—Si—Cr-based | Nanocrystal | None | 90 | 2.2 |
| 136 | Example | Fe—Co—B—P—Si—Cr-based | Nanocrystal | None | 110 | 9.1 |

According to Tables 8A to 8C, even when the composition of the soft magnetic metal powder was changed, similar results were obtained. Particularly, in the case that Co was included in the soft magnetic metal powder, the m-value tended to improve.

### REFERENCE SIGNS LIST

1 . . . Soft magnetic metal particle
2 . . . Core Part
10 . . . Covering Part
11 . . . Oxide part
12 . . . C-concentrated part
13 . . . Outer coating part
50 . . . Mixture
100 . . . Powder coating device
101 . . . Rotor
102 . . . Press head

What is claimed is:

1. A soft magnetic metal powder, comprising:
a soft magnetic metal particle comprising a core part and a covering part,
wherein the covering part comprises a C-concentrated part having a higher concentration of C than in the core part.

2. The soft magnetic metal powder according to claim 1, wherein the covering part comprises an oxide part contacting a surface of the core part.

3. The soft magnetic metal powder according to claim 1, wherein a local maximum of the concentration of C in the C-concentrated part (C(LM)) is ten times or greater than the concentration of C in the soft magnetic metal powder (C(P)).

4. The soft magnetic metal powder according to claim 1, wherein a thickness of the C-concentrated part is 0.5 nm or thicker and 50.0 nm or thinner.

5. The soft magnetic metal powder according to claim 1, wherein the covering part comprises an outer coating part contacting a surface of the C-concentrated part.

6. A magnetic core comprising the soft magnetic metal powder according to claim 1.

7. A magnetic component comprising the soft magnetic metal powder according to claim 1.

8. An electronic device including the soft magnetic metal powder according to claim 1.
